(19) United States
(12) Patent Application Publication
(10) Pub. No.: US 2023/0243184 A1
(43) Pub. Date: Aug. 3, 2023

(54) Telescopic electromechanical dual-control smart lock

(71) Applicant: YOHO INNOVATIVE TECHNOLOGY LIMITED, Hong Kong (CN)

(72) Inventors: MAN SHUN SERVER LEUNG, Hong Kong (CN); LOK SHUN LEUNG, Hong Kong (CN)

(21) Appl. No.: 16/321,454

(22) PCT Filed: Dec. 28, 2017
(86) PCT No.: PCT/CN2018/121489

§ 371 Date: Jan. 28, 2019

(30) Foreign Application Priority Data
Dec. 28, 2017 (CN) 201711452837.X

(51) Int. Cl. E05B 47/00; H02K 7/116; H01M 50/262

(52) U.S. Cl. CPC E05B 47/0012; H01M 50/262; H02K 7/116; E05B 2047/002; E05B 2047/0017; E05B 2047/0025; E05B 2047/0035; E05B 2047/0058

(57) ABSTRACT

A telescopic electromechanical dual-control smart lock includes: a lock cylinder mechanism, a transmission mechanism and a power supply control mechanism; wherein the lock cylinder mechanism comprises a bolt, a lock core PCB (printed circuit board), a positive electrode sheet, a negative electrode sheet and a first spring; the power supply control mechanism comprises a main control PCB and a detachable battery; wherein the positive electrode sheet, the negative electrode sheet and the transmission mechanism are electrically connected with the lock core PCB respectively; wherein a first end of the transmission mechanism is pressed against an end of the first spring; a second end of the transmission mechanism is fixedly connected with the bolt; is the lock cylinder mechanism and the transmission mechanism are provided side by side, and the main control PCB is electrically connected with the lock core PCB and the detachable battery respectively.

### CROSS REFERENCE OF RELATED APPLICATION

This is a U.S. National Stage under 35 U.S.C 371 of the International Application PCT/CN2018/121489, filed Dec. 17, 2018, which claims priority under 35 U.S.C. 119(a-d) to CN201711452837.X, filed Dec. 28, 2017.

### BACKGROUND OF THE PRESENT INVENTION

### Field of Invention

The present invention relates to the technical field of daily hardware articles, and more particular to a telescopic electromechanical dual-control smart lock.

### Description of Related Arts

With the rapid development of the Internet, smart phones have become a necessity in life, and smart access control system has also developed immediately. Many electronically controlled door locks, fingerprint locks, and etc. can be used combining with smart phones. While human inertia is not replaced by full intelligence, when new smart products are developed, whether the product meets the needs of different age groups, such as the elderly or users who have not yet used a smart phone is firstly considered. In addition to being compatible with the unlocking method of the existing conventional lock key, the design can be optimized during use, and can be manipulated with a more convenient smart phone without contradiction in use.

### SUMMARY OF THE PRESENT INVENTION

In view of the shortcomings in the technology mentioned above, the present invention provides a telescopic electromechanical dual-control smart lock that adds smart control without changing the original mechanical mode.

Accordingly, in order to accomplish the above objects, the present invention provides a telescopic electromechanical dual-control smart lock, comprising: a lock cylinder mechanism, a transmission mechanism and a power supply control mechanism; wherein the lock cylinder mechanism comprises a bolt, a lock core PCB (printed circuit board) board, a positive electrode sheet, a negative electrode sheet and a first spring; the power supply control mechanism comprises a main control PCB board and a detachable battery; wherein the positive electrode sheet, the negative electrode sheet and the transmission mechanism are electrically connected with the lock core PCB board respectively; wherein a first end of the transmission mechanism is pressed against an end of the first spring; a second end of the transmission mechanism is fixedly connected with the bolt; when the first spring is pressed, the bolt is retracted, and when the first spring is expanded, the bolt is stretched out; the lock cylinder mechanism and the transmission mechanism are provided side by side, and the main control PCB board is electrically connected with the lock core PCB board and the detachable battery respectively.

Preferably, transmission mechanism comprises a motor, a gear set, a rotating ring, and a jacket, wherein two sets of spring pieces are symmetrically provided on an external wall of the rotating ring; a curved upward track and a right angle sliding track are provided on an internal wall of the jacket; the motor drives the rotating ring to rotate through the gear set, and the protruding nails on the rotating ring are received in the curved track and alternately slide between the curved upward track and the right angle sliding track; once the motor is started, the rotating ring rotates, the protruding nails slide along the curved upward rails, the bolt are retracted, the motor is restarted, and the rotating ring continues to rotate, the protruding nail slides along the right angle sliding track to the starting point of the curved upward rail, and the bolt is ejected by the first spring.

Preferably, the gear set comprises a driving wheel and a driven wheel; wherein the driving wheel is fixed on a rotating shaft of the motor, gear openings matched with the driven wheel are provided on an internal wall of the rotating ring; a first end of the driven wheel is engaged with the driving wheel; and a second end of the driven wheel is engaged with the internal wall of the rotating ring.

Preferably, wherein the transmission mechanism further comprises a shaft bracket and a spring positioning kit; the shaft bracket comprises a stretching rod, a stretching rod and a fixing portion; wherein the stretching rod, the stretching rod and the fixing portion are in an integrated structure; a spring positioning kit is sleeved on an external of the motor, the fixing portion is clamped in an external surface groove of the spring positioning assembly, and the gear set is received in the gear housing portion, and the gear housing portion is provided with openings for engaging the driven wheel and the rotating ring; the stretching rod passes through the first spring and is mechanically connected with a manual unlocking structure.

Preferably, the positive electrode sheet is composed of two sets of positively symmetrical metal sheets, each of which comprises a first positive electrode sheet and a second positive electrode sheet; wherein the first positive electrode sheet comprises a curved metal strip and two first positive straight strips, the curved metal strips are matched with the curved upper track, and the two first positive straight strips are respectively led out from both ends of the curved metal strip and electrically connected to the lock core PCB; the second positive electrode sheet comprises a horizontal belt and a second positive straight belt; a first end of the horizontal belt is adjacent to an end of the curved metal strip, and a second end of the horizontal belt is connected to the second positive straight belt; the second positive straight belt is electrically connected with the lock core PCB.

Preferably, the lock cylinder mechanism further comprises an FPCB and a symmetrically disposed spring piece, which is sandwiched between the motor and the bolt, the spring piece passes through the spring piece positioning kit, and a first end of the spring piece is electrically connected with the FPCB board, and a second end of the spring piece is electrically connected to the negative electrode sheet; the negative electrode sheet is composed of two sets of negative electrode metal sheets which are symmetric in center, and each set of the negative electrode metal sheets comprise strip-shaped metal sheets.

Preferably, the power supply control mechanism further comprises a connection terminal and a connection circuit board; wherein the connection circuit board is disposed in parallel with the main control PCB through a lead board, and a first end of the connection terminal is connected to the connection circuit board; and a second end of the connection terminal 33 is in contact with the lock core PCB.

Preferably, the connection terminal comprises a set of negative terminal and two sets of positive terminals; wherein a first end of the negative terminal is provided with two contacts electrically connected to the lock core PCB, and a second end of the negative terminal is provided with a contact electrically connected to the connecting circuit board; the two sets of positive terminals are respectively disposed on two sides of the negative terminal, and a first set of the positive terminals are electrically connected to the first positive electrode, and a second set of the positive terminals are electrically connected with the second positive electrode; a first end of each set of positive electrode terminals is provided with a contact electrically connected to the lock core PCB, and a second end of each set of the positive electrode terminals is provided with a contact electrically connected to the connection circuit board.

Preferably, the smart lock further comprises a first cover, a second cover, a first shell, and a second shell; wherein the first shell is sleeved on an external surface of the lock cylinder mechanism, and the first cover is fixedly connected to the first shell by a fixing screw; the second external shell is sleeved on the external surface of the power supply control mechanism, and the second cover is closed at an opening of the second shell.

Preferably, the power supply control mechanism further comprises a fastening cover and a second spring; wherein the fastening cover is provided with a fixing protrusion for facilitating detachable connection with the second cover, and a sliding slot is provided at the opening of the second cover, a first end of the second spring is jacking and holding at a bottom of an installing position of the battery; a second end of the second spring is jacking and holding on an installing groove of the door; when the fastening cover is fastened, the second spring is in a contracted state, when the snap cover is rotated to open, the second spring is unfolded, and the battery and the main control PCB are pushed out.

The beneficial effects of the invention are as follows.

Compared with the conventional art, by adding the transmission mechanism and the power supply control mechanism, the original mechanical lock cylinder is combined with the smart lock cylinder, and the transmission mechanism is controlled by the main control PCB, which can be adaptive to the mechanical structure of the door with the lock of the lock cylinder of the original drawer or cabinet. Through the design of the simple and single mechanical movement of the back and forth movement, and with the simplest installation procedure, without the need to replace or modify the drawer, the door, without wiring, the conventional standard locks are converted into smart locks. At the same time, after installing the smart lock, in addition to using the original key for unlocking, the smart phone can also be used to control and collect data, and the data can be uploaded to the cloud internet database through the smart terminal.

### BRIEF DESCRIPTION OF THE DRAWINGS

FIG. 1 is a schematic structural view of a telescopic electromechanical dual-control smart lock of the present invention.

FIG. 2 is a schematic structural view of a gear set of the present invention.

FIG. 3 is a schematic structural view of a rotating ring of the present invention;

FIG. 4 is a schematic view showing an internal structure of a half pipe jacket of the present invention;

FIG. 5 is a partial exploded view of a transmission mechanism of the present invention;

FIG. 6 is a schematic structural view of a shaft bracket of the present invention;

FIG. 7 is a schematic structural view of a positive electrode sheet of the present invention.

FIG. 8 is a schematic structural view of a negative electrode sheet of the present invention.

FIG. 9 is a partial structural view of a lock cylinder mechanism of the present invention.

FIG. 10 is a schematic structural view of a connection terminal of the present invention.

FIG. 11 is a partial schematic structural view of a power supply control mechanism of the present invention.

Main component symbols are described below.
1-lock cylinder mechanism;
2-transmission mechanism;
3-power supply control mechanism;
4- first cover;
5-second face cover;
6-first shell;
7-second shell;
11- bolt;
12-lock core PCB (printed circuit board) board;
13-positive electrode sheet;
14-negative electrode sheet;
15-the first spring;
16-FPCB (flexible printed circuit board) board;
17-spring piece;
131-first positive electrode sheet;
132-second positive electrode sheet;
21- motor;
22-gear set;
23- rotating ring;
24-jacket
25- shaft bracket;
26-the spring positioning kit;
221-driving wheel;
222-driven wheel;
231- raised nail;
241- curved upward track;
242-right angle sliding track;
251- stretching rod;
252-gear housing portion;
253-fixing portion;
31-main control PCB board;
32- detachable battery;
33-connecting terminal;
34-connecting circuit board;
35- second spring;
36-snap cover;
331-negative terminal;
332-positive terminal.

### DETAILED DESCRIPTION OF THE PREFERRED EMBODIMENT

In order to illustrate the present invention more apparent, further description of the present invention is illustrated combining with the accompanying drawings.

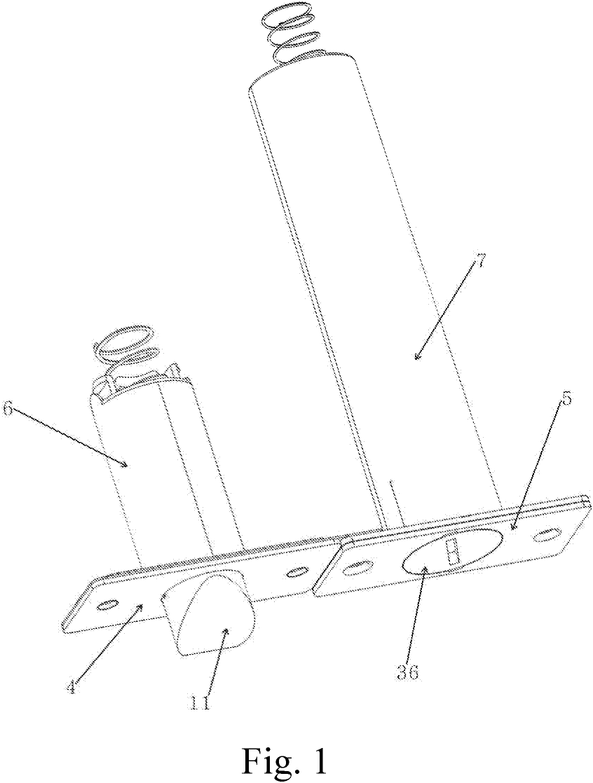

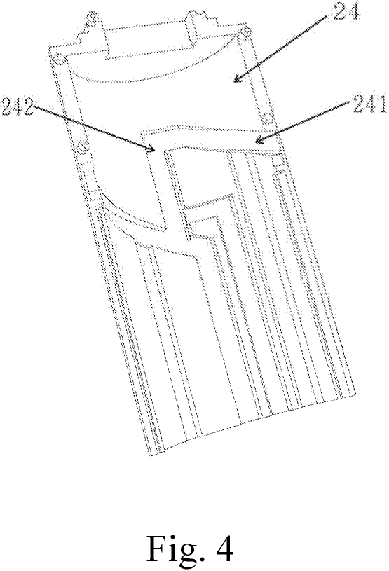

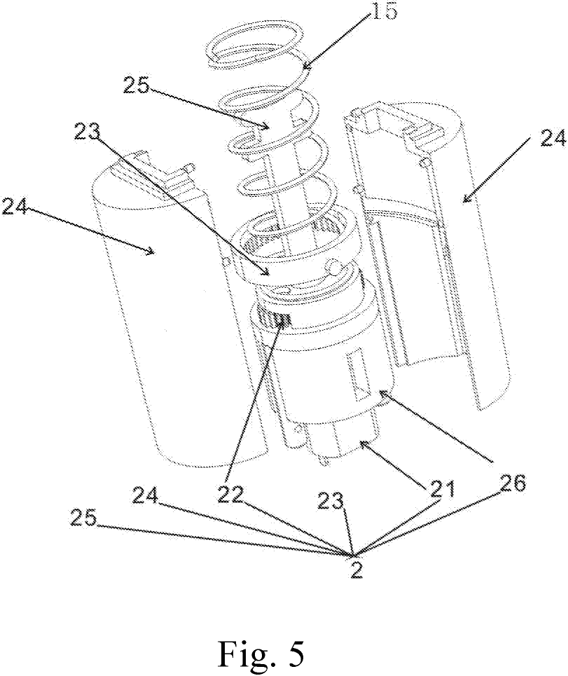

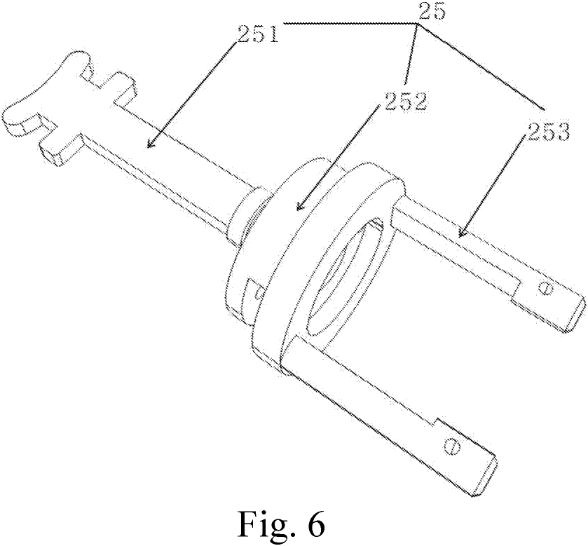

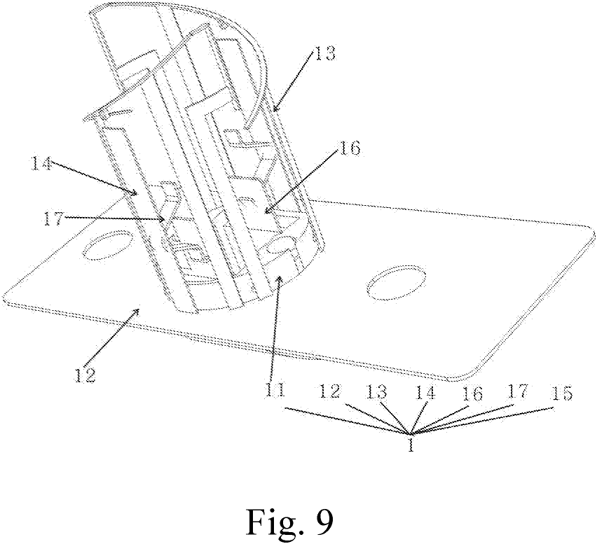

Referring to FIGS. 1-9, the present invention provides a telescopic electromechanical dual-control smart lock, comprising: a lock cylinder mechanism 1, a transmission mechanism 2 and a power supply control mechanism 3; wherein the lock cylinder mechanism 1 comprises a bolt 11, a lock core PCB (printed circuit board) board 12, a positive electrode sheet 13, a negative electrode sheet 14 and a first spring 15; the power supply control mechanism 3 comprises a main control PCB board 31 and a detachable battery 32; wherein the positive electrode sheet 13, the negative electrode sheet 14 and the transmission mechanism 2 are electrically connected with the lock core PCB board 12 respectively; wherein a first end of the transmission mechanism 2 is pressed against an end of the first spring 15; a second end of the transmission mechanism 2 is fixedly connected with the bolt 11; when the first spring 15 is pressed, the bolt 11 is retracted, and when the first spring 15 is expanded, the bolt 11 is stretched out; the lock cylinder mechanism 1 and the transmission mechanism 2 are provided side by side, and the main control PCB board 31 is electrically connected with the lock core PCB board 12 and the detachable battery 32 respectively.

Compared with the conventional art, by additionally providing the transmission mechanism 2 and the power supply control mechanism 3, the conventional mechanical lock cylinder is combined with the smart lock cylinder. The transmission mechanism 2 is controlled by the main control PCB board 31, so as to be adaptive to the conventional mechanical structure designed for lockset adopting lock cylinder of the conventional drawer or cupboard door, by designing simple and single back and forth mechanical clutch, with a simplest installation procedure, without replacing or modifying the drawer and the door, and without arrangement of wire, the conventional standard lock is converted into a smart lock. Meanwhile, after installing the smart lock, besides unlocking with the original key, controlling and collecting data by a smart mobile phone, and the data can be unloaded to a cloud internet database by a smart terminal.

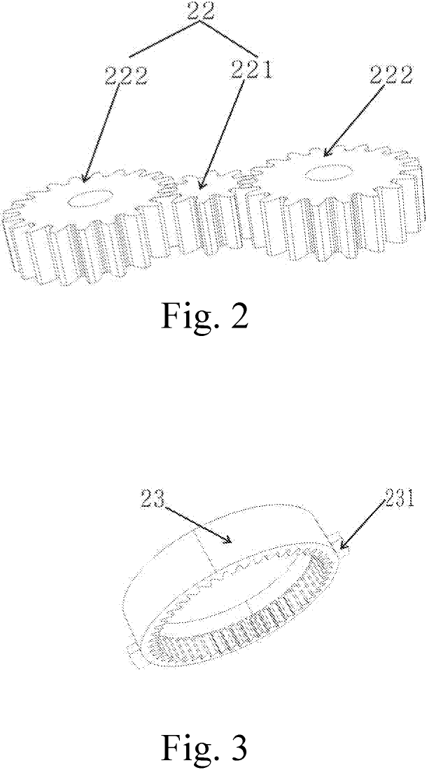

Further referring to FIGS. 2-6, the transmission mechanism 2 comprises a motor 21, a gear set 22, a rotating ring 23, and a jacket 24, wherein two sets of spring pieces are symmetrically provided on an external wall of the rotating ring 23; a curved upward track 241 and a right angle sliding track 242 are provided on an internal wall of the jacket 24; the motor 21 drives the rotating ring 23 to rotate through the gear set 22, and the protruding nails 231 on the rotating ring 23 are received in the curved track and alternately slide between the curved upward track 241 and the right angle sliding track 242; once the motor 21 is started, the rotating ring 23 rotates, the protruding nails 231 slide along the curved upward rails 241, the bolt 11 are retracted, the motor 21 is restarted, and the rotating ring 23 continues to rotate, the protruding nail 231 slides along the right angle sliding track 242 to the starting point of the curved upward rail 241, and the bolt 11 is ejected by the first spring 15.

In the present embodiment, the gear set 22 comprises a driving wheel 221 and a driven wheel 222. The driving wheel 221 is fixed on a rotating shaft of the motor 21, gear openings matched with the driven wheel 222 are provided on an internal wall of the rotating ring 23; a first end of the driven wheel 222 is engaged with the driving wheel 221; and a second end of the driven wheel 222 is engaged with the internal wall of the rotating ring 23.

In the preferred embodiment, the transmission mechanism 2 further comprises a shaft bracket 25 and a spring positioning kit 26; the shaft bracket 25 comprises a stretching rod 251, a stretching rod 252 and a fixing portion 253; wherein the stretching rod 251, the stretching rod 252 and the fixing portion 253 are in an integrated structure. A spring positioning kit 26 is sleeved on an external of the motor 21, the fixing portion 253 is clamped in an external surface groove of the spring positioning assembly 26, and the gear set 22 is received in the gear housing portion 252, and the gear housing portion 252 is provided with openings for engaging the driven wheel 222 and the rotating ring 23; the stretching rod 251 passes through the first spring 15 and is mechanically connected with a manual unlocking structure.

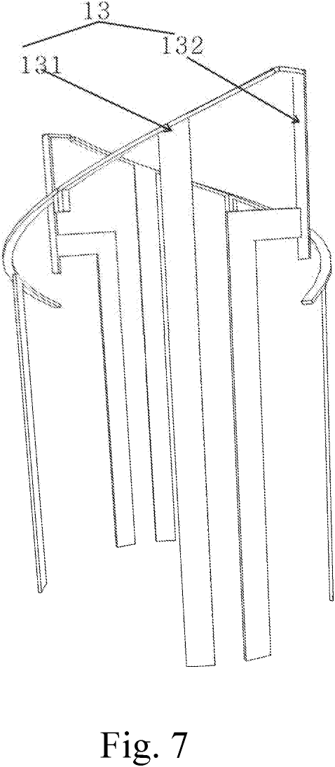

Referring to FIG. 7, the positive electrode sheet 13 is composed of two sets of positively symmetrical metal sheets, each of which comprises a first positive electrode sheet 131 and a second positive electrode sheet 132; wherein the first positive electrode sheet 131 comprises a curved metal strip and two first positive straight strips, the curved metal strips are matched with the curved upper track 241, and the two first positive straight strips are respectively led out from both ends of the curved metal strip and electrically connected to the lock core PCB 12; the second positive electrode sheet 132 comprises a horizontal belt and a second positive straight belt; a first end of the horizontal belt is adjacent to an end of the curved metal strip, and a second end of the horizontal belt is connected to the second positive straight belt; the second positive straight belt is electrically connected with the lock core PCB 12.

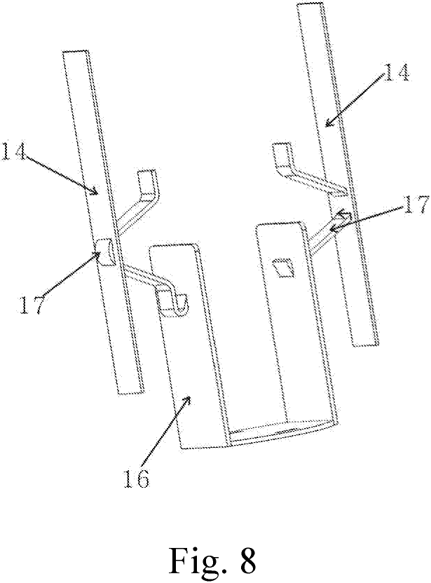

Further referring to FIG. 8, the lock cylinder mechanism 1 further comprises an FPCB 16 and a symmetrically disposed spring piece 17, which is sandwiched between the motor 21 and the bolt 11, the spring piece 17 passes through the spring piece positioning kit 26, and a first end of the spring piece 17 is electrically connected with the FPCB board 16, and a second end of the spring piece 17 is electrically connected to the negative electrode sheet 14; the negative electrode sheet 14 is composed of two sets of negative electrode metal sheets which are symmetric in center, and each set of the negative electrode metal sheets comprise strip-shaped metal sheets.

A positive electrode point and a negative electrode point are drawn on the motor 21, and the FPCB 16 is provided with a positive electrode connection position and a negative electrode connection position which are matched with the positive electrode point and the negative electrode point of the motor 21; the positive connection position of the FPCB 16 is electrically connected to the bolt 11 through conductive sponge, and the bolt 11 transmits current to the rotating ring 23 through a fixing portion 253 of a center shaft bracket 25, and the protruding nail 231 of the rotating ring 23 is contacted with the first positive electrode 131 and the second positive electrode 132; the negative electrode connection position of the FPCB 16 is electrically connected to the negative electrode sheet 14 through the spring piece 17.

Shapes of the positive electrode sheet 13 and the negative electrode sheet 14 are both matched with the tracks in an interlayer; the motor 21 is started to drive the protruding nails 231 slide in the arc-shaped ascending track, and when the protruding nails 231 are rotated to a position where the first positive electrode and the second positive electrode are contacted, due to jacking and holding of the protruding nail 231, the first positive electrode is disconnected from the second positive electrode, the motor 21 stops moving, the bolt 11 is retracted into the door to be stationary; and when the motor 21 is started again, under an action of inertia, the protruding nail 231 is swept forward to a right angle drop edge position of the second positive electrode, and the spring nail 231 slides down to an origin of a second curved rising track under an action of the spring force. Therefore, as long as the motor 21 is remotely controlled, the projecting nail 231 is capable of being reciprocating moving in the track, and telescopic control of the bolt 11 is convenient.

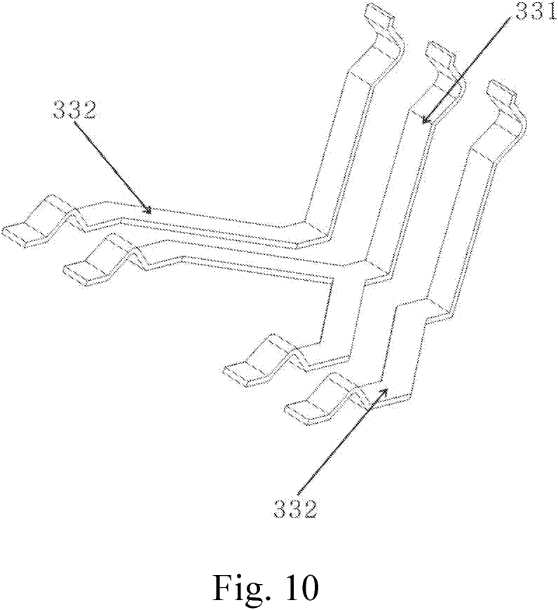

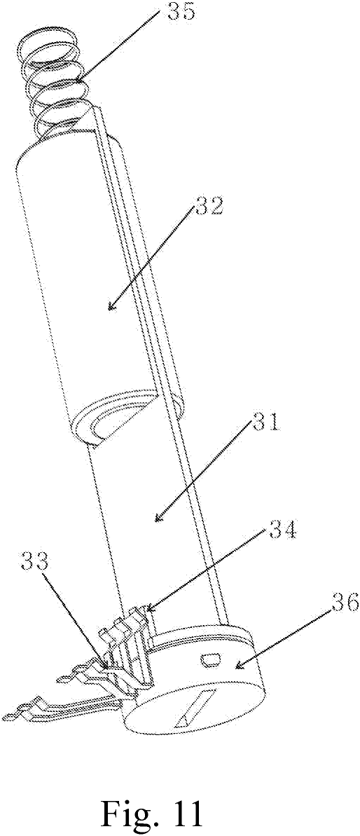

Referring further to FIGS. 10-11, the power supply control mechanism 3 further comprises a connection terminal 33 and a connection circuit board 34; wherein the connection circuit board 34 is disposed in parallel with the main control PCB 31 through a lead board, and a first end of the connection terminal 33 is connected to the connection circuit board 34; and a second end of the connection terminal 33 is in contact with the lock core PCB 12.

In the present embodiment, the connection terminal 33 comprises a set of negative terminal 331 and two sets of positive terminals 332; wherein a first end of the negative terminal 331 is provided with two contacts electrically connected to the lock core PCB 12, and a second end of the negative terminal 331 is provided with a contact electrically connected to the connecting circuit board 34; the two sets of positive terminals 332 are respectively disposed on two sides of the negative terminal 331, and a first set of the positive terminals 332 are electrically connected to the first positive electrode 131, and a second set of the positive terminals are electrically connected with the second positive electrode 132; a first end of each set of positive electrode terminals 332 is provided with a contact electrically connected to the lock core PCB 12, and a second end of each set of the positive electrode terminals 332 is provided with a contact electrically connected to the connection circuit board 34.

In the preferred embodiment, the smart lock further comprises a first cover 4, a second cover 5, a first shell 6, and a second shell 7; wherein the first shell 6 is sleeved on an external surface of the lock cylinder mechanism 1, and the first cover 4 is fixedly connected to the first shell 6 by a fixing screw; the second external shell 7 is sleeved on the external surface of the power supply control mechanism 3, and the second cover 5 is closed at an opening of the second shell 7.

In the preferred embodiment, the power supply control mechanism 3 further comprises a fastening cover 36 and a second spring 35; wherein the fastening cover 36 is provided with a fixing protrusion for facilitating detachable connection with the second cover 5, and a sliding slot is provided at the opening of the second cover 5, a first end of the second spring 35 is jacking and holding at a bottom of an installing position of the battery; a second end of the second spring 35 is jacking and holding on an installing groove of the door; when the fastening cover 36 is fastened, the second spring 35 is in a contracted state, when the snap cover 36 is rotated to open, the second spring 35 is unfolded, and the battery and the main control PCB 31 are pushed out.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A telescopic electromechanical dual-control smart lock, comprising: a lock cylinder mechanism, a transmission mechanism and a power supply control mechanism; wherein the lock cylinder mechanism comprises a bolt, a lock core PCB (printed circuit board) board, a positive electrode sheet, a negative electrode sheet and a first spring; the power supply control mechanism comprises a main control PCB board and a detachable battery; wherein the positive electrode sheet, the negative electrode sheet and the transmission mechanism are electrically connected with the lock core PCB board respectively; wherein a first end of the transmission mechanism is pressed against an end of the first spring; a second end of the transmission mechanism is fixedly connected with the bolt; when the first spring is pressed, the bolt is retracted, and when the first spring is expanded, the bolt is stretched out; the lock cylinder mechanism and the transmission mechanism are provided side by side, and the main control PCB board is electrically connected with the lock core PCB board and the detachable battery respectively.

2. The telescopic electromechanical dual-control smart lock, as recited in claim 1, wherein transmission mechanism comprises a motor, a gear set, a rotating ring, and a jacket, wherein two sets of spring pieces are symmetrically provided on an external wall of the rotating ring; a curved upward track and a right angle sliding track are provided on an internal wall of the jacket; the motor drives the rotating ring to rotate through the gear set, and the protruding nails on the rotating ring are received in the curved track and alternately slide between the curved upward track and the right angle sliding track; once the motor is started, the rotating ring rotates, the protruding nails slide along the curved upward rails, the bolt are retracted, the motor is restarted, and the rotating ring continues to rotate, the protruding nail slides along the right angle sliding track to the starting point of the curved upward rail, and the bolt is ejected by the first spring.

3. The telescopic electromechanical dual-control smart lock, as recited in claim 2, wherein the gear set comprises a driving wheel and a driven wheel; wherein the driving wheel is fixed on a rotating shaft of the motor, gear openings matched with the driven wheel are provided on an internal wall of the rotating ring; a first end of the driven wheel is engaged with the driving wheel; and a second end of the driven wheel is engaged with the internal wall of the rotating ring.

4. The telescopic electromechanical dual-control smart lock, as recited in claim 3, wherein the transmission mechanism further comprises a shaft bracket and a spring positioning kit; the shaft bracket comprises a stretching rod, a stretching rod and a fixing portion; wherein the stretching rod, the stretching rod and the fixing portion are in an integrated structure; a spring positioning kit is sleeved on an external of the motor, the fixing portion is clamped in an external surface groove of the spring positioning assembly, and the gear set is received in the gear housing portion, and the gear housing portion is provided with openings for engaging the driven wheel and the rotating ring; the stretching rod passes through the first spring and is mechanically connected with a manual unlocking structure.

5. The telescopic electromechanical dual-control smart lock, as recited in claim 4, wherein the positive electrode sheet is composed of two sets of positively symmetrical metal sheets, each of which comprises a first positive electrode sheet and a second positive electrode sheet; wherein the first positive electrode sheet comprises a curved metal strip and two first positive straight strips, the curved metal strips are matched with the curved upper track, and the two first positive straight strips are respectively led out from both ends of the curved metal strip and electrically connected to the lock core PCB; the second positive electrode sheet comprises a horizontal belt and a second positive straight belt; a first end of the horizontal belt is adjacent to an end of the curved metal strip, and a second end of the horizontal belt is connected to the second positive straight belt; the second positive straight belt is electrically connected with the lock core PCB.

6. The telescopic electromechanical dual-control smart lock, as recited in claim 4, wherein the lock cylinder mechanism further comprises an FPCB and a symmetrically disposed spring piece, which is sandwiched between the motor and the bolt, the spring piece passes through the spring piece positioning kit, and a first end of the spring piece is electrically connected with the FPCB board, and a second end of the spring piece is electrically connected to the negative electrode sheet; the negative electrode sheet is composed of two sets of negative electrode metal sheets which are symmetric in center, and each set of the negative electrode metal sheets comprise strip-shaped metal sheets.

7. The telescopic electromechanical dual-control smart lock, as recited in claim 1, wherein the power supply control mechanism further comprises a connection terminal and a connection circuit board; wherein the connection circuit board is disposed in parallel with the main control PCB through a lead board, and a first end of the connection terminal is connected to the connection circuit board; and a second end of the connection terminal 33 is in contact with the lock core PCB.

8. The telescopic electromechanical dual-control smart lock, as recited in claim 7, wherein the connection terminal comprises a set of negative terminal and two sets of positive terminals; wherein a first end of the negative terminal is provided with two contacts electrically connected to the lock core PCB, and a second end of the negative terminal is provided with a contact electrically connected to the connecting circuit board; the two sets of positive terminals are respectively disposed on two sides of the negative terminal, and a first set of the positive terminals are electrically connected to the first positive electrode, and a second set of the positive terminals are electrically connected with the second positive electrode; a first end of each set of positive electrode terminals is provided with a contact electrically connected to the lock core PCB, and a second end of each set of the positive electrode terminals is provided with a contact electrically connected to the connection circuit board.

9. The telescopic electromechanical dual-control smart lock, as recited in claim 1, wherein the smart lock further comprises a first cover, a second cover, a first shell, and a second shell; wherein the first shell is sleeved on an external surface of the lock cylinder mechanism, and the first cover is fixedly connected to the first shell by a fixing screw; the second external shell is sleeved on the external surface of the power supply control mechanism, and the second cover is closed at an opening of the second shell.

10. The telescopic electromechanical dual-control smart lock, as recited in claim 9, wherein the power supply control mechanism further comprises a fastening cover and a second spring; wherein the fastening cover is provided with a fixing protrusion for facilitating detachable connection with the second cover, and a sliding slot is provided at the opening of the second cover, a first end of the second spring is jacking and holding at a bottom of an installing position of the battery; a second end of the second spring is jacking and holding on an installing groove of the door; when the fastening cover is fastened, the second spring is in a contracted state, when the snap cover is rotated to open, the second spring is unfolded, and the battery and the main control PCB are pushed out.
